(19) United States
(12) Patent Application Publication
(10) Pub. No.: US 2016/0267380 A1
(43) Pub. Date: Sep. 15, 2016

(54) Method and System for Training a Neural Network

(71) Applicant: Nuance Communications, Inc., Burlington, MA (US)

(72) Inventors: Roberto Gemello, Alpignano (IT); Dario Albesano, Venaria Reale (IT); Franco Mana, Torino (IT)

(21) Appl. No.: 14/657,414

(22) Filed: Mar. 13, 2015

(51) Int. Cl. G06N 3/08; G06N 3/04

(52) U.S. Cl. CPC G06N 3/084; G06N 3/04

(57) ABSTRACT

Training a neural network is a time consuming and computationally expensive task. Embodiments provide efficient methods and systems for neural network training One example embodiment is implemented by a plurality of agents, where each agent performs a pipelined gradient analysis to update respective local models of the neural network using respective subsets of data from a common pool of training data. In turn, a common global model of the neural network is updated based upon the local models.

### BACKGROUND OF THE INVENTION

Achieved advances in speech processing and media technology have led to a wide use of automated user machine interaction across different applications and services. Using an automated user machine interaction approach, businesses may provide customer services and other services with relatively inexpensive cost.

Typical user machine interaction is implemented through use of speech recognition systems. Speech recognition systems convert input audio, including speech, to recognized text. During recognition, acoustic waveforms are typically divided into a sequence of discrete time vectors (e.g., 10 ms segments) called “frames,” and one or more of the frames are converted into sub-word (e.g., phoneme or syllable) representations using various approaches. According to one such example approach, input audio is compared to a set of templates, and the sub-word representation for the template in the set that most closely matches the input audio is selected as the sub-word representation for that input. In yet another approach, statistical modeling is used to convert input audio to a sub-word representation (e.g., to perform acoustic-phonetic conversion). When statistical modeling is used, acoustic waveforms are processed to determine feature vectors for one or more of the frames of the input audio, and statistical models are used to assign a particular sub-word representation to each frame based on its feature vector.

Hidden Markov Models (HMMs) are statistical models that are often used in speech recognition to characterize the spectral properties of a sequence of acoustic patterns. For example, acoustic features of each frame of input audio may be modeled by one or more states of an HMM to classify the set of features into phonetic-based categories. Gaussian Mixture Models (GMMs) are often used within each state of an HMM to model the probability density of the acoustic patterns associated with that state. Artificial neural networks (ANNs) may alternatively be used for acoustic modeling in a speech recognition system. ANNs may be trained to estimate the posterior probability of each state of an HMM given an acoustic pattern. Some statistical-based speech recognition systems favor the use of ANNs over GMMs due to better accuracy in recognition results and faster computation times of the posterior probabilities of the HMM states.

### SUMMARY OF THE INVENTION

Embodiments of the present invention provide methods and apparatuses that support training neural networks. According to at least one example embodiment, a method of training a neural network comprises: by each agent of a plurality of agents, performing a pipelined gradient analysis to update respective local models of a neural network using respective subsets of data from a common pool of training data; and updating a common global model of the neural network based upon the local models. In an example embodiment, the pipelined gradient analysis is performed by splitting the respective local models of the neural network into consecutive chunks and assigning each chunk to a stage of the pipeline.

In yet another example embodiment, each stage of the pipeline is associated with a graphics processing unit (GPU). Further still, embodiments may perform the pipelined gradient analysis by selecting the subsets of data from the common pool of training data according to a focused-attention back-propagation (FABP) strategy. An alternative embodiment, performed according to the principles of the present invention, includes an initialization procedure where a single agent of the plurality of agents performs the pipelined gradient analysis to update its respective local model of the neural network using a respective subset of data from the common pool of training data. This initialization procedure further includes updating the common global model of the neural network based upon the respective local model.

According to an embodiment, the common global model is owned by a single agent of the plurality of agents at any one time, and this ownership is regulated by a locking mechanism. In such an embodiment, the common global model is updated by a single agent during a period in which the single agents owns the common global model. In another embodiment of the present invention, the common global model is updated when a critical section is reached. In such an embodiment, the critical section may be defined by a point when a multitude of agents of the plurality of agents need to update the common model. In yet another embodiment, a critical section is reached when an agent of the plurality is ready to update the global model and the agent of the plurality that is ready to update the global model does not own the global model. In such an embodiment, the agent that is ready to update the global model may request the global model.

An alternative embodiment of the present invention is directed to a computer system for training a neural network. Such a computer system embodiment comprises a processor and a memory with computer code instructions stored thereon. The processor and the memory, according to such an embodiment, with the computer code instructions, are configured to cause the system to: by each agent of a plurality of agents, perform a pipelined gradient analysis to update respective local models of a neural network using respective subsets of data from a common pool of training data; and update a common global model of the neural network based upon the local models.

According to an embodiment of the system, in performing the pipelined gradient analysis, the processor and the memory, with the computer code instructions, are further configured to cause the system to split the respective local models of the neural network into consecutive chunks and assign each chunk to a stage of a pipeline. In embodiments, a “chunk” may be a portion of the neural network, e.g. one or more blocks of weights where a block of weights is the weights connecting two consecutive DNN layers. Further still, according to an embodiment, each stage of the pipeline may be associated with a GPU. In yet another computer system embodiment, in performing the pipelined gradient analysis, the processor and the memory, with the computer code instructions, are further configured to cause the system to select the subsets of data used for the analysis from the common pool of training data according to a FABP strategy.

Another embodiment of the system employs an initialization procedure. According to one such embodiment, the processor and the memory, with the computer code instructions, are further configured to implement the initialization procedure that causes the system to: by a single agent of the plurality of agents, perform the pipelined gradient analysis to update its respective local model of the neural network using a respective subset of data from the common pool of training data and update the common global model of the neural network based upon its local model. According to yet another embodiment, the common global model is owned by a single agent of the plurality of agents at any one time according to a locking mechanism. In such an embodiment, the common global model is updated by the single agent during a period in which the single agents owns the common global model.

In yet another example computer system embodiment, a critical section is reached when an agent of the plurality is ready to update the global model and the agent of the plurality that is ready to update the global model does not own the global model. In such an embodiment, the agent that is ready to update the global model may request the global model.

An embodiment of the present invention is directed to a computer program product for training a neural network. The computer program product, according to such an embodiment, comprises one or more computer readable tangible storage devices and program instructions stored on at least one of the one or more storage devices. The program instructions, when loaded and executed by a processor, cause an apparatus associated with the processor to: cause each agent of a plurality of agents to perform a pipelined gradient analysis to update respective local models of a neural network using respective subsets of data from a common pool of training data and update a common global model of the neural network based upon the local models.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a simplified block diagram of a system for training a neural network, during a first iteration, according to an embodiment.

FIG. 1B is a simplified block diagram of the system of FIG. 1A for training a neural network during a subsequent iteration.

FIG. 2 is a timing diagram for updating a model of a neural network according to an embodiment.

FIG. 3 depicts an agent that may be utilized for training a neural network according to embodiments of the present invention.

FIG. 4 is a simplified block diagram illustrating the pipelined gradient analysis that may be employed in embodiments of the present invention.

FIG. 5 is a flowchart depicting a method for training a neural network according to at least one example embodiment.

FIG. 6 is a visual depiction of a computer system for training a neural network according to an embodiment of the present invention.

### DETAILED DESCRIPTION OF THE INVENTION

A description of example embodiments of the invention follows.

The teachings of all patents, published applications, and references cited herein are incorporated by reference in their entirety.

It should be understood that the terms neural network, artificial neural network (ANN), and deep neural network (DNN) are used interchangeably herein.

As described hereinabove, neural networks may be used in speech recognition applications. One such ANN commonly used for speech recognition is the feed-forward multi-layer perceptron (MLP). This neural network includes a plurality of layers of nodes forming a directed graph. The most basic MLP includes an input layer and an output layer. MLPs with three or more layers are also commonly referred to as DNNs and include one or more “hidden” layers arranged between the input and output layers. Each layer in the MLP includes a plurality of processing elements called nodes, which are connected to other nodes in adjacent layers of the network. The connections between nodes are associated with weights that define the strength of association between the nodes. Each node is associated with non-linear activation functions that define the output of the node given one or more inputs. Typical activation functions used for input and hidden layers in an ANN are sigmoid functions or Rectified Linear Units, whereas a softmax function is often used for the output layer.

While neural networks may be favored over existing approaches due to increased accuracy in recognition results and faster computation times of the posterior probabilities of the Hidden Markov Model (HMM) states, ANNs are not without their drawbacks. ANNs and their associated functions require a significant amount of training on example speech patterns to achieve an acceptable level of accuracy. This training requires a significant amount of time and can be computationally very expensive. It is not uncommon for ANN training using a single processor to take approximately one to two weeks or even longer, depending upon the size of the pool of training data. Further, while parallelization is a common technique used in computer systems to speed up processing times, ANN training is not easily amenable to parallelization. Training of a DNN is particularly difficult to parallelize due to the use of small mini-batches and the need to update the model after each mini-batch has been processed. Difficulties in training ANNs are further described in Zhang et al., “Asynchronous Stochastic Gradient Descent For DNN Training,” the contents of which are herein incorporated by reference.

Existing methods of data parallelization of stochastic gradient descent (a neural network training methodology) utilize a central coordinator (parameter server) and several computation agents. Each agent has a replica of the whole model and its own shard of the training data. At each training step, each agent gets the latest available model from the parameter server, computes the variations of the model on its own data shard, and sends the variations to the parameter server. This is a poor solution to use in neural network training because back-propagation uses small mini-batches and the model parameters need to be updated after every mini-batch processing, which results in a very high model and gradients exchange rate.

Thus, embodiments of the present invention introduce a hierarchical approach to neural network training that employs data parallelization and multi-GPU (graphics processing unit) pipelined parallelization to achieve a significant speed up in neural network training time. Described hereinbelow are example method and system embodiments for neural network training that employ pipelined data parallelization techniques according to the principles of the present invention.

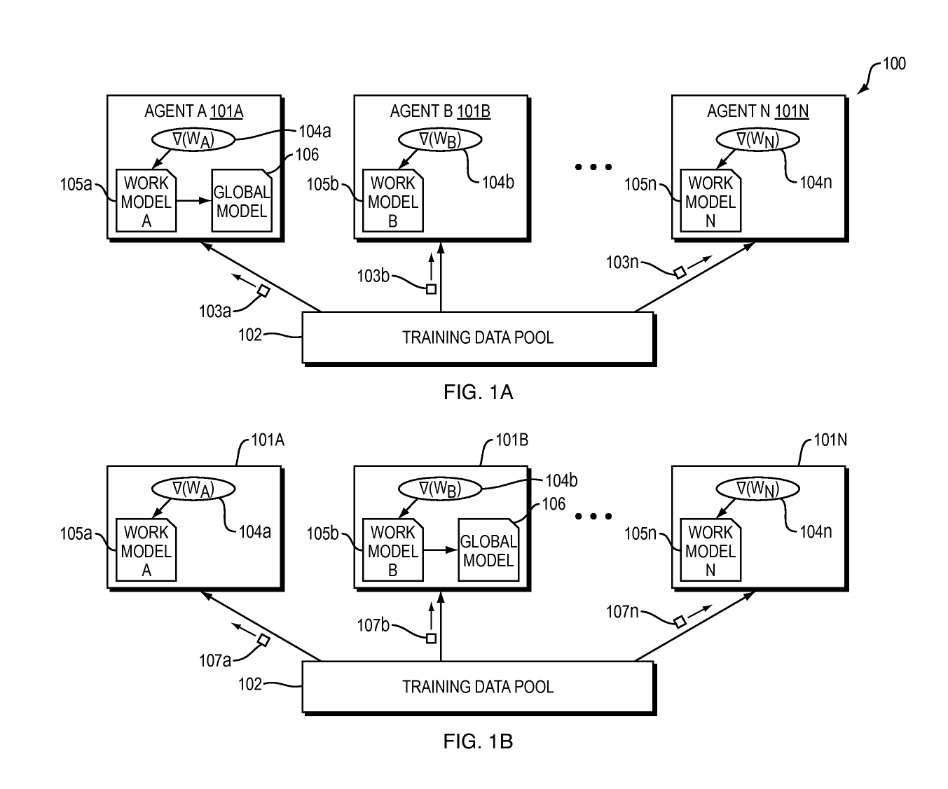

FIGS. 1A and 1B illustrate a simplified system 100, for training a neural network, during a first iteration and during a subsequent iteration respectively, according to an embodiment. The system 100 includes the agents 101A-N and the training data pool 102. According to an embodiment, during the first iteration, the agent 101A, agent 101B, and agent 101N each receive respective subsets 103a-n of the training data 102. In this way, the system 100 implements data parallelization. The system 100 does not require that the agents operate in a synchronized matter, for example, the agents 101A-N may receive their training data 103a-n at different times. Furthermore, according to an embodiment of the system 100, the data 103a-n is not all of the training data 102; instead, the data 103a-n is limited to subsets of the training data 102. Thus, the data is not split a-priori into shards, but each agent 101A-N gets data from the common pool 102 when necessary. This is beneficial because a significant portion of data is not lost in the event an agent fails. Furthermore, because the agents 101A-N are not required to operate in a synchronized fashion at all times, slower agents do not slow down the entire training process.

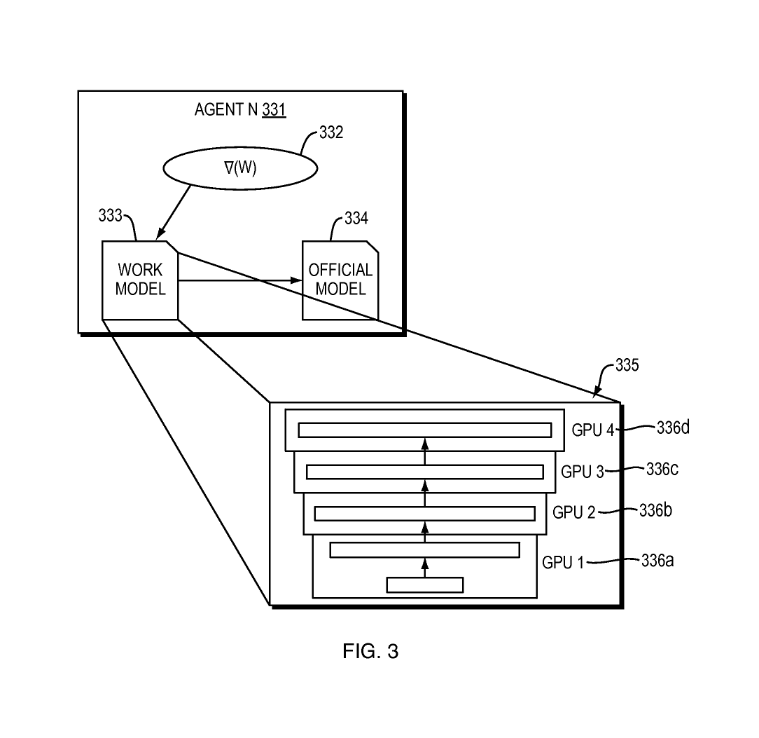

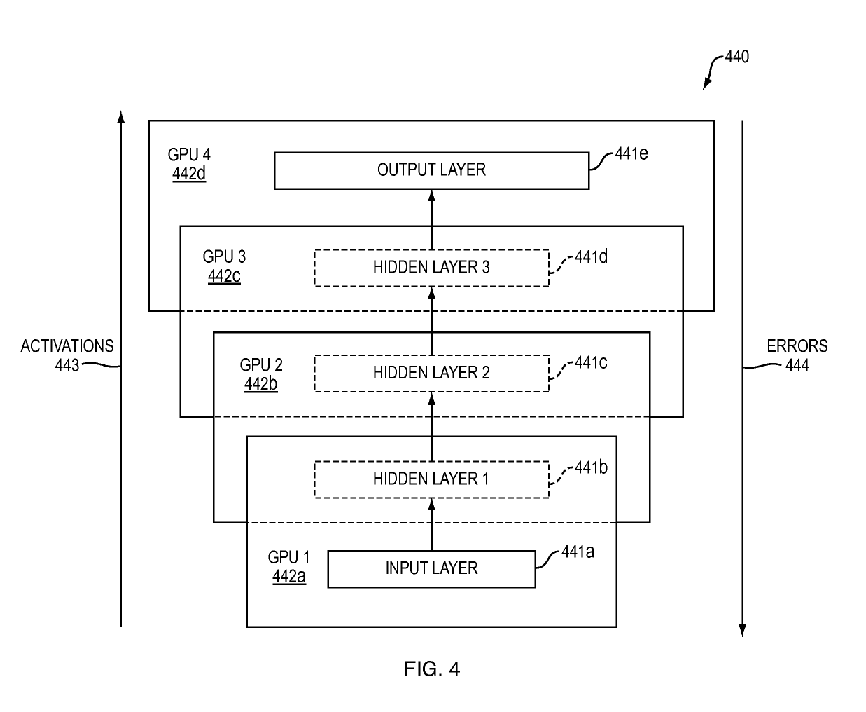

Once each agent 101A-N has the training data 103a-n, each respective agent 101A-N performs a respective gradient analysis 104a-n. According to embodiments of the present invention, the gradient analysis 104a-n is a pipelined gradient analysis. Further detail regarding the gradient analysis 104a-n is described hereinbelow in relation to FIGS. 3 and 4. Further, each agent 101A-N updates a respective local work model 105a-n of the neural network using the results of the gradient analysis 104a-n. It should be understood that the agents 101A-N may perform several iterations of the above-described process of receiving data, performing a gradient analysis, and updating a local model. In this way, the gradient computation may be iterated inside the agent before updating the global model.

As described hereinabove, FIG. 1A depicts the system 100 during a first iteration. During the first iteration the agent 101A owns the global model 106. According to an embodiment using the principles of the present invention, the agent 101A-N that owns the global model 106 updates the global model 106 based upon the agent's local work model 105. In the example depicted in FIG. 1A, agent A 101A updates the global model 106 based upon the updates to its respective local model 105a. Thus, reflecting the gradient analysis 104a performed using the data 103a in the global model 106. According to an embodiment of the system 100, the agent A 101A will copy the updated global model 106 after updating the global model 106, which results in the local model 105a being identical to the newly updated global model 106. This allows the agent A 101A to use the newly updated global model 106 as the local model 105a for subsequent gradient calculations 104a.

At this point, the global model 106 only includes the results from the gradient analysis 104a performed by the agent A 101A; thus, embodiments of the system 100 must proceed to update the global model 106 to reflect changes to the other local work models 105b-n.

FIG. 1B depicts the system 100 during a subsequent iteration. During this subsequent iteration the global model 106 is owned by the agent B 101B. According to an embodiment, the global model 106 is not transferred in a deterministic way or at fixed time intervals, but instead the global model 106 is transferred and ownership is changed based upon an agent's 101A-N demand. For example, the second iteration depicted in FIG. 1B may be triggered by the agent B 101B requesting the global model 106. In such an embodiment, an agent 101A-N makes the demand when that agent is ready to update the global model 106. Further detail regarding ownership, timing, and transfer of the global model according to embodiments of the present invention is described hereinbelow. During the subsequent iteration depicted in FIG. 1B each agent 101A-N receives a respective subset of training data 107a-n. The agents 101A-N then, in turn, perform respective gradient analyses 104a-n using the data 107a-n and update the respective local models 105a-n. Further, while FIG. 1B depicts each agent receiving training data 107a-n during this subsequent iteration, embodiments of the present invention are not so limited. Instead, agents 101A-N may only receive training data when necessary. Further, the agent B 101B updates the global model 106 based upon the respective local model 105b in the same manner as described hereinabove in relation to the agent A 101A. In this way, the global model 106 is updated with the gradient analysis 104b performed using the training data 103b and 107b.

The system 100 can proceed in the manner described above to continue training the neural network model 106 using the remaining training data 102. The global model 106 can be transferred to any number of agents 101 in the system 100, and once owned by each respective agent, the global model can be updated to include the results of each respective gradient analysis 104 that is reflected in the respective working models 105.

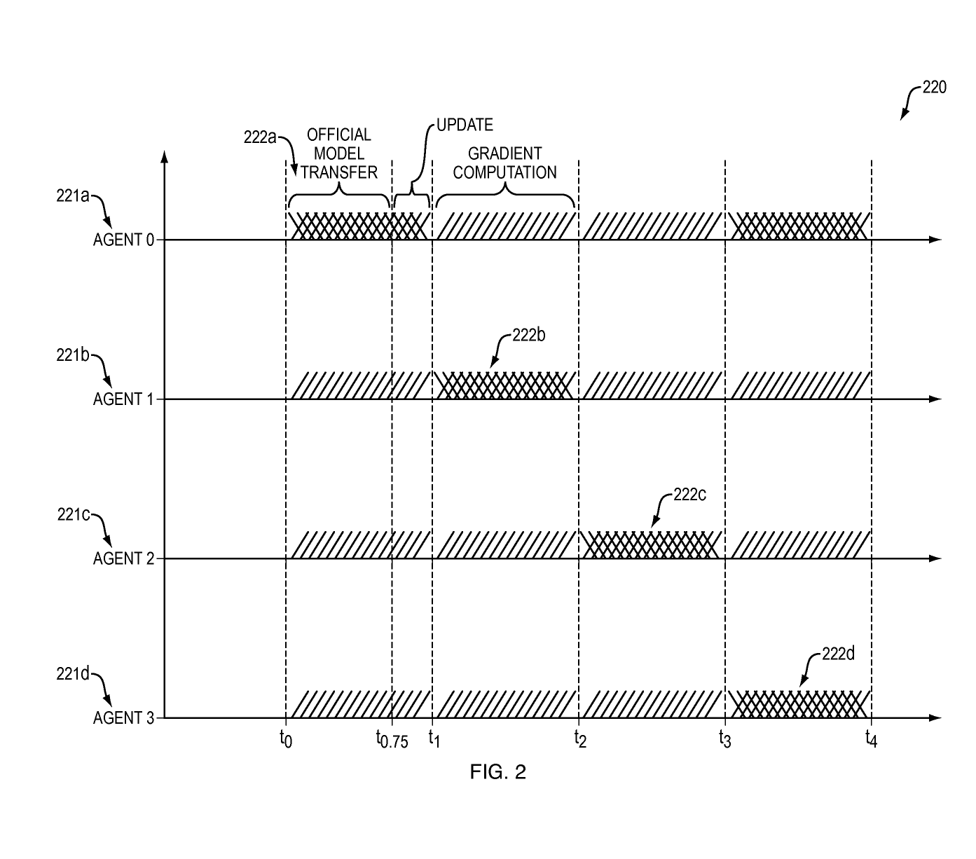

FIG. 2 is a timing diagram 220 of global model transfer and update that may be utilized by embodiments of the present invention. For example, the system 100 and the agents 101A-N may employ the timing diagram 220 to govern transferring and updating the global model 106. According to the timing diagram 220, the agent 221a is transferred and updates the model (222a) in the time slot t₀ to t₁. At this time, t₀ to t₁, the agents 221b-d are performing the gradient computation as described herein. During the t₁ to t₂ time slot, the official model is transferred from the agent 221a to the agent 221b, and the agent 221b updates the model (222b). Similar, to the previous time slot, the agents 221a, 221c, and 221d are performing a gradient computation. This timing process 220 continues and the global model is transferred to, and updated by the agent 221c during the t₂ to t₃ time slot. At this time, t₂ to t₃, the agents 221a, 221b, and 221d perform the gradient analysis. Finally, the depicted timing diagram concludes during the time slot t₃ to t₄ when the global model is transferred to, and updated by the agent 221d and the agents 221a-c perform the gradient computation. This timing pattern can be continued until the neural network is sufficiently trained. Moreover, while the timing diagram 220 illustrates timing using the four agents, 221a-d, the timing diagram 220 can be adapted to be carried out with any number of agents.

The timing/transfer method 220 is but one example method that may be utilized by embodiments of the present invention. Alternative embodiments are not limited to any fixed timing. The agents instead may employ non-deterministic, parallel, and asynchronous methods for training a neural network. In such an asynchronous method, the agents perform respective gradient analyses and then, when an individual agent is ready to update the global model, that agent requests the global model from the agent that currently owns the model. If in that moment, the global model is being downloaded/updated by another agent, then the requesting agent waits and retries.

These timing/transfer methods allow the global model to be updated without utilizing a central server that can become a bottleneck. Instead, embodiments of the present invention utilize a locking mechanism where ownership of the global neural network model is dynamically allocated and owned by the most recent agent that updated it. This rotational ownership can be employed such that each agent only downloads the global model when the agent needs to apply gradient changes. Such a method helps to prevent model transfers and, thus, reduces the use of bandwidth. The locking mechanism may be implemented using any method that can implement a critical section, such as a mutex locking protocol.

FIG. 3 is simplified diagram illustrating an agent 331 and pipeline process 335 that may be employed by the agent 331 in an embodiment of the present invention. As described herein, embodiments of the present invention leverage several agents; thus, the agent 331 is an example agent configuration that may be utilized by each agent operating in accordance with the principles of the present invention. The agent 331 includes a module 332 for performing a gradient analysis. The gradient analysis module 332 updates the work model 333 using the pipelined processing method 335. The pipeline process 335 employs the four GPUs 336a-d to perform the gradient computations using provided training data. Further details regarding the pipelined analysis 335 are described hereinbelow in relation to FIG. 4.

Training a neural network is an iterative process that includes processing operations for determining node activations in the feed-forward direction (i.e., from an input layer to an output layer) and propagation of network errors in the backward direction (i.e., from an output layer to an input layer). Network errors are a measure of difference between actual outputs of the neural network and an expected output given a particular input. One such technique for training a neural network is the supervised learning technique called backpropagation. This technique relies on iterative gradient descent optimizations to minimize the network errors in the neural network by adjusting the connection weights between the nodes.

FIG. 4 depicts an ANN 440 that includes five layers, the input layer 441a, an output layer 441e, and three hidden layers 441b-d arranged between the input and output layers. Each of the layers may include any suitable number of nodes. For example, 465 nodes for input, 2048 nodes for hidden layers, and 10000 nodes for output. The number of network weights to be determined for each training iteration is the product of the number of nodes in adjacent layers. While three hidden layers are depicted, 441b-d, it should be appreciated that any suitable number of hidden layers may be used by embodiments of the present invention. The multi-layer structure of the ANN 440 facilitates parallel processing using multiple simultaneously active processors (GPUs) 442a-d. When the depicted ANN 440 is used for speech recognition, the inputs to the input layer 441a are a plurality of audio frames (e.g., 10 ms in length) comprising speech. In some embodiments, rather than processing individual frames, multiple frames (e.g., 9-15 frames) are processed together as an input block, and data for multiple time-sequential blocks may be stored in a data structure (e.g., a matrix) to be processed as input.

In ANN training, the feed-forward computation determines, for each layer, the output network activations 443 of the corresponding nodes given a layer input vector. After the forward stage, the outputs for nodes in each layer in the ANN are used to determine network errors 444, which are then updated in a backpropagation stage during which the errors are propagated from the output layer 441e to underlying hidden layers 441b-d in the ANN 440.

The processing in the architecture of FIG. 4 is pipelined in that the data output from one GPU flows to the next GPU, as in an assembly line. At least one layer is shared between multiple GPUs acting both as the output layer for a lower order layer and as an input layer for a higher order layer. As shown in FIG. 4, data flows from the GPU 442a to GPU 442b, to GPU442c, to GPU 442d in the feed-forward direction, and from GPU 442d to GPU 442c, to GPU 442b, to GPU442a in the backpropagation direction.

According to embodiments of the present invention, all GPUs 442 are configured to work simultaneously on the data they have. In the simplest case, the number of layers (hidden and output) equals the number of GPUs, and each GPU is assigned to process calculations for a single layer. If the number of layers in the ANN exceeds the number of GPUs, multiple layers may be grouped on a GPU. Moreover, while four layers, each with a corresponding GPU are depicted, embodiments of the present invention may utilize any number of layers and corresponding GPUs, for example between four and eight.

Each input pattern travels twice per GPU, once in the feed-forward direction and once for backpropagation. Because the data needed for an update of the neural network arrives at a delay due to the pipeline roundtrip, updates to the network weights in the ANN use delayed data, and the deeper the network (i.e., due to more layers), the longer the delay. As the activation computations in the feed-forward direction and the error computations in the backpropagation are out of sync, queues of activations from the feed-forward direction may be kept to compute the weight variations with the corresponding activations and errors. The activation queues can be used to compensate for the delay introduced by the resulting lack of synchronization of the weights used in the forward and backward propagation caused by the delayed network weight updates introduced by the pipeline.

Furthermore, while the pipeline method in FIG. 4 is described in relation to a single pipeline, embodiments of Applicant's claimed invention are not so limited. According to the principles of the present invention, each agent may employ any of the pipelined processing methods described herein. Further still, agents operating in accordance with the principles of the present invention may implement any pipelined processing technique described in U.S. patent application Ser. No. 14/308,054, entitled “Methods and Apparatus For Training An Artificial Neural Network For Use In Speech Recognition,” the entire contents of which are herein incorporated by reference.

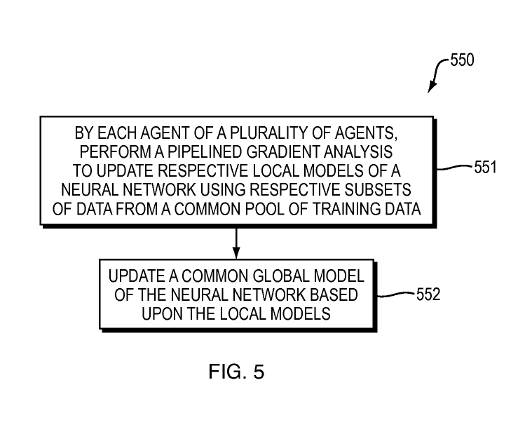

FIG. 5 is a flow diagram of a method 550 for training a neural network according to an embodiment of the present invention. The method 550 begins by each agent, of a plurality of agents, performing a pipelined gradient analysis to update respective local models of a neural network using respective subsets of data from a common pool of training data (551). The agents performing the method 550 may be as described hereinabove in relation to FIG. 3. Moreover, the pipelined gradient analysis may be performed according to any method described herein.

The method 550 continues by updating a common global model of the neural network based upon the local models. The common model may be updated (552) according to the principles described herein. For example, the method 550 may utilize a locking procedure and employ the timing described hereinabove in relation to FIG. 2 so that a single agent owns the global model at a given time and, when that agent owns the model, the agent updates the global model to reflect gradient calculations that are in the agent's respective local model.

According to an embodiment of the method 550, performing the pipelined gradient analysis (551) comprises splitting the respective local models of the neural network into consecutive chunks and assigning each chunk to a stage of a pipeline. In such an embodiment, this may be performed by each agent of the plurality of agents so as to implement a method where every agent is performing a pipelined analysis. Further still, according to an embodiment, each stage of the pipeline may be associated with a GPU, where the GPUs perform the gradient analysis. Moreover, in an embodiment where the neural network is split into consecutive chunks and each chunk is assigned a stage in the pipeline, each stage may be assigned a respective GPU. In this way, embodiments may provide DNN multi-GPU parallel training through hierarchical data splitting and pipelining.

According to yet another example embodiment of the method 550, performing the pipelined gradient analysis (551) may further include selecting the subsets of data from the common pool of training data according to a focused-attention back-propagation (FABP) or stochastic data sweeping strategy. In such an embodiment, the selected data is used to perform the pipelined gradient analysis (551).

Embodiments of the method 550 may further employ an initialization procedure. An example initialization procedure is implemented by a single agent of the plurality. In such an embodiment, the single agent performs the pipelined gradient analysis using a subset of data from the common pool of training data and, further, updates the common global model of the neural network based upon its local model. In an example embodiment, an agent may perform the initialization procedure using a pre-established amount of the training data, for example, 20%. Yet another initialization procedure includes one agent of the plurality performing the analysis and then at some subsequent time, the remaining agents starting the analysis. In such an embodiment, the agents may all start performing the analysis during a first iteration. In yet another embodiment, an initialization procedure may be performed where each agent is started gradually during the first iteration, for example at regular intervals of time, e.g. a first agent at time t=0, a second agent at time t=T, and a third agent at time t=2T, etc.

According to an embodiment of the method 550, the common global model is owned by a single agent of the plurality of agents at any one time according to a locking mechanism. In such an embodiment, the common global model is updated by the single agent during a period in which the single agent owns the common global model. According to such an embodiment, the plurality of agents work in conjunction to implement said locking mechanism. According to an example locking mechanism, upon beginning the method 550, a single agent owns the common global model. As the method 550 progresses, a critical section is reached, and when this critical section is reached, the agent owning the global model updates the model to reflect all of the changes to its respective local model that were determined by the gradient analysis. The common global model is then transferred to a next agent of the plurality to allow that agent to update the common global model. In such an embodiment, a critical section is a point when a multitude of agents of the plurality of agents may need to update a same section of the common model but when only one agent of the plurality may update the model at a time. In other words, the critical section is entered when an agent of the plurality has reached a point in processing when it is ready to update the global model but when it does not own the global model. At this point, the agent that is ready to update the global model needs to download the global model from the agent that currently owns it. However, if the global model is being updated by the agent that owns it, then the critical section prevents the agent requesting the global model from performing the download and queues the download request. When the agents that owns the global model finishes modifying the global model, it than exits the critical section and makes the global model public, i.e. available to be downloaded by another agent. At this point the agent in the critical section queue can lock, download, and modify the global model. Thus, the critical section also serves to manage a queue of agents that have requested the model and implements exclusive access to the global model.

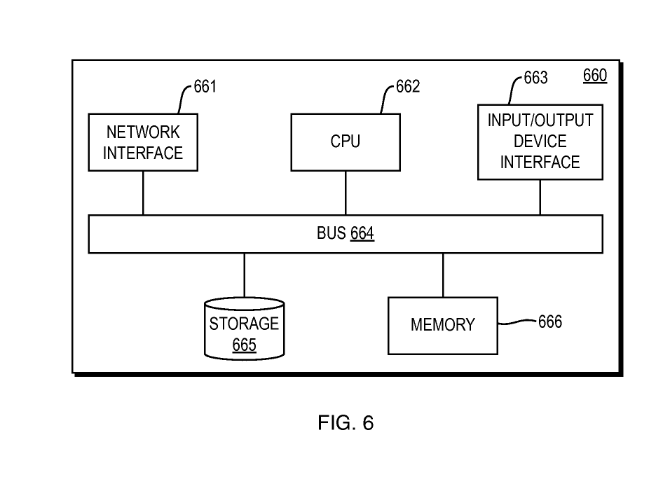

FIG. 6 is a simplified block diagram of a computer-based system 660, which may be used to train a neural network according to the principles of the present invention. The system 660 comprises a bus 664. The bus 664 serves as an interconnect between the various components of the system 660. Connected to the bus 660 is an input/output device interface 663 for connecting various input and output devices, such as a keyboard, mouse, display, speakers, etc. to the system 660. A central processing unit (CPU) 662 is connected to the bus 664 and provides for execution of computer instructions. Memory 666 provides volatile storage for data used for carrying out computer instructions. Storage 665 provides non-volatile storage for software instructions, such as an operating system (not shown). The system 660 also comprises a network interface 661 for connecting to any variety of networks known in the art, including wide area networks (WANs) and local area networks (LANs).

The system 660 may implement any method described herein. For example, the CPU 662 and memory 666 and/or storage 665, with computer code instructions stored thereon, may be configured to cause the system 660 to provide a plurality of agents each configured to perform a pipelined gradient analysis to update respective local models of a neural network using respective subsets of data from a common pool of training data and, in turn, update a common global model of the neural network based upon the local models.

Various hardware components may be used in performing the above-described methods and, further, this variety of hardware components may be configured in numerous ways to implement the various methods and systems described hereinabove. One example embodiment of the present invention is implemented using a single server with four agents, each using a pipelined parallelization on four GPUs. In such an embodiment, the GPUs connected on the first PCIe of the server may contain stages one and two of the pipelines, and the GPUs connected on the second PCIe of the server may contain stage three and four of the four pipelines. Thus, utilizing sixteen GPUs provided by the server. Further, the agents may be executed by CPU threads, among other examples.

As described herein, the agents utilize two shared information resources: the official model and the training data. According to embodiments, the agents may be configured to access the official model in a devoted critical region, i.e. section, and similarly pick up new training data in a devoted critical region. This ensures that no two agents can access the same training data or modify the global model at a given time. In order to minimize computational costs, embodiments may further utilize conditional events to make agents “sleep” when the training data is finished and “wake-up” when the last agent concludes its processing. Moreover, in another embodiment, each agent may be configured to allocate its respective local model on GPU memory, thus avoiding transfers from CPU to GPU RAM and, in turn, further increasing computational efficiency.

The methods and systems may be tuned and varied so as to employ the most efficient approaches given available hardware and software. One example architecture may employ a server of sixteen GPUs that can implement four agents each using a pipeline length of four.

The described training techniques were tested for validation. Experiments involved tuning the following recipes:

1) Large DNN Scorer for NCS US English

Experimental setup:
Features: 31 lossless MFCC, context=15 (total: 31×15=465)
Training set: NCS US English data (˜1300 h)
DNN: Scorer with architecture 465-7*2048-256-10000 (sigmoid hidden units+softmax outputs)
Test: Mrec test (dragonGo_16k)

In this case the following configurations were tested:
no agents, pipeline=1 (baseline mono-GPU)
no agents, pipeline=4 (pipelined parallelization only)
4 agents, pipeline=1 (data parallelization only)
4 agents, pipeline=4 (data parallelization+pipelined parallelization)

The results are shown below in Table 1.

TABLE 1

| | Pipeline | # local | Final | | | |
|---|---|---|---|---|---|---|
| # Agents | length | Gradients | MSE | WER | Time (sec) | Speed-up |
| no | 1 | no | 0.663 | 10.26 | 312 h 57 m | — |
| no | 4 | no | 0.671 | 10.05 | 84 h 35 m | 3.7x |
| 4 | 1 | 4 | 0.667 | 9.98 | 82 h 02 m | 3.8x |
| 4 | 4 | 4 | 0.675 | 10.10 | 32 h 43 m | 9.6x |

2) Increasing the Number of GPUs

Using the same case study as above, this experiment increased the number of GPU jobs, moving from 16 (DP=4, PP=4) to 32 (DP=8, PP=4) and 64 (DP=16, PP=4). Such a method requires 32/64 GPUs on the same server, but may be implemented using 16 GPUs in time sharing. This is useful so as to fully load the GPUs, masking the model transfer time of data parallelization (DP) and the imperfect balancing of pipelined parallelization (PP). Table 2 below shows the GPU loading of this experiment.

TABLE 2

| | | # of GPU | 16 GPU |
|---|---|---|---|
| DP | PP | tasks | load |
| 4 | 4 | 16 | 65.2% |
| 8 | 4 | 32 | 81.7% |
| 16 | 4 | 64 | 91.5% |

The results from increasing the number of GPUs is shown below in Table 3.

TABLE 3

| # | | # of | # local | | 16 | | | |
|---|---|---|---|---|---|---|---|---|
| A- | Pipeline | GPU | Gradi- | Final | GPU | | Time | Speed- |
| gents | length | tasks | ents | MSE | load | WER | (sec) | up |
| no | 1 | 1 | no | 0.663 | 6.2% | 10.26 | 312 h | — |
| | | | | | | | 57 m | |
| no | 4 | 4 | no | 0.671 | 19.8% | 10.05 | 84 h | 3.7x |
| | | | | | | | 35 m | |
| 4 | 4 | 16 | 4 | 0.675 | 65.2% | 10.10 | 32 h | 9.6x |
| | | | | | | | 43 m | |
| 8 | 4 | 32 | 6 | 0.670 | 81.7% | 10.11 | 23 h | 13.2x |
| | | | | | | | 41 m | |
| 16 | 4 | 64 | 10 | 0.679 | 91.5% | 10.25 | 20 h | 15.4x |
| | | | | | | | 15 m | |

As shown above, 32 logical GPUs (mapped on 16 physical GPUs) resulted in a 37% speed-up and 64 logical GPUs (mapped on 16 physical GPUs) resulted in 60% speed-up. These experiments show that hierarchical integration of data splitting and pipelining make the parallelization more efficient and lead to large speed-ups. On a large DNN scorer trained with approximately 1300 hours of data, the total speed-up was 9.6 times and achieved by running 16 jobs on 16 GPUs in parallel. The aforementioned speed-up can be improved to 15.4× by running 64 jobs on 16 GPUs with DP=16 and PP=4. Thus, training a similar size DNN with 10,000 hours of data would take approximately 6 days instead of 3 months. This could be even further reduced if the training is implemented on a single server with 32 physical GPUs.

It should be understood that the example embodiments described above may be implemented in many different ways. In some instances, the various methods and machines described herein may each be implemented by a physical, virtual, or hybrid general purpose computer, or a computer network environment.

Embodiments or aspects thereof may be implemented in the form of hardware, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should also be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

While this invention has been particularly shown and described with references to example embodiments thereof, it will be understood by those skilled in the art that various changes in form and details may be made therein without departing from the scope of the invention encompassed by the appended claims.

What is claimed is:

1. A method of training a neural network, the method comprising:
by each agent of a plurality of agents, performing a pipelined gradient analysis to update respective local models of a neural network using respective subsets of data from a common pool of training data; and
updating a common global model of the neural network based upon the local models.

2. The method of claim 1 wherein performing the pipelined gradient analysis comprises:
splitting the respective local models of the neural network into consecutive chunks; and
assigning each chunk to a stage of a pipeline.

3. The method of claim 1 wherein each stage of the pipeline is associated with a graphics processing unit (GPU).

4. The method of claim 1 wherein performing the pipelined gradient analysis further comprises:
selecting the subsets of data from the common pool of training data according to a focused-attention back-propagation (FABP) strategy.

5. The method of claim 1 further including an initialization procedure comprising:
by a single agent of the plurality of agents:
performing the pipelined gradient analysis to update its respective local model of the neural network using a respective subset of data from the common pool of training data; and
updating the common global model of the neural network based upon its local model.

6. The method of claim 1 wherein the common global model is owned by a single agent of the plurality of agents at any one time according to a locking mechanism.

7. The method of claim 6 wherein the common global model is updated by the single agent during a period in which the single agent owns the common global model.

8. The method of claim 1 wherein a critical section is reached when an agent of the plurality is ready to update the global model and the agent of the plurality that is ready to update the global model does not own the global model.

9. The method of claim 8 wherein the agent that is ready to update the global model requests the global model.

10. A computer system for training a neural network, the computer system comprising:
a processor; and
a memory with computer code instructions stored thereon, the processor and the memory, with the computer code instructions being configured to cause the system to:
by each agent of a plurality of agents, perform a pipelined gradient analysis to update respective local models of a neural network using respective subsets of data from a common pool of training data; and
update a common global model of the neural network based upon the local models.

11. The computer system of claim 10, wherein, in performing the pipelined gradient analysis, the processor and the memory, with the computer code instructions, are further configured to cause the system to:
split the respective local models of the neural network into consecutive chunks; and
assign each chunk to a stage of a pipeline.

12. The computer system of claim 10 wherein each stage of the pipeline is associated with a graphics processing unit (GPU).

13. The computer system of claim 10, wherein, in performing the pipelined gradient analysis, the processor and the memory, with the computer code instructions, are further configured to cause the system to:
select the subsets of data from the common pool of training data according to a focused-attention back-propagation (FABP) strategy.

14. The computer system of claim 10, wherein the processor and the memory, with the computer code instructions, are further configured to implement an initialization procedure that causes the system to:
by a single agent of the plurality of agents:
perform the pipelined gradient analysis to update its respective local model of the neural network using a respective subset of data from the common pool of training data; and
update the common global model of the neural network based upon its local model.

15. The computer system of claim 10 wherein the common global model is owned by a single agent of the plurality of agents at any one time according to a locking mechanism.

16. The computer system of claim 15 wherein the common global model is updated by the single agent during a period in which the single agent owns the common global model.

17. The computer system of claim 10 wherein a critical section is reached when an agent of the plurality is ready to update the global model and the agent of the plurality that is ready to update the global model does not own the global model.

18. The computer system of claim 17 wherein the agent that is ready to update the global model requests the global model.

19. A computer program product for training a neural network, the computer program product comprising:
one or more computer-readable tangible storage devices and program instructions stored on at least one of the one or more storage devices, the program instructions, when loaded and executed by a processor, cause an apparatus associated with the processor to:
cause each agent of a plurality of agents to perform a pipelined gradient analysis to update respective local models of a neural network using respective subsets of data from a common pool of training data; and
update a common global model of the neural network based upon the local models.

20. The computer program product of claim 19 wherein the program instruction further cause the apparatus to cause each agent to perform the pipelined gradient analysis by:
splitting the respective local models of the neural network into consecutive chunks; and
assigning each chunk to a stage of a pipeline.
